(19) United States
(12) Patent Application Publication
(10) Pub. No.: US 2008/0267100 A1
(43) Pub. Date: Oct. 30, 2008

(54) Data block cluster processing in a wireless device

(75) Inventors: Nelson R. Sollenberger, Farmingdale, NJ (US); Srirang Ashok Lovlekar, Iselin, NJ (US); Hui Luo, Marlboro, NJ (US); Hendrik Frederick Bruyns, San Diego, CA (US); Khoi Ly, San Diego, CA (US); Xiaoxin Qiu, Bridgewater, NJ (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/796,167

(22) Filed: Apr. 27, 2007

(51) Int. Cl. H04B 7/00; H04B 1/38; H04B 1/66

(52) U.S. Cl. 370/310; 375/241; 455/73

(57) ABSTRACT

A wireless device includes a case, user interface, an antenna, first processing resources, and second processing resources. The first processing resources couple to the antenna and to the second processing resources and receive and operate upon a data signal transmitted by a transmitting wireless device. In its processing operations, the first processing resources produces decoded data blocks and writes the decoded data blocks to a data buffer. When a processing resource threshold is met with regard to the plurality of decoded data blocks, the first processing resources issue a service processing interrupt to the second processing resources. In response to the service processing interrupt, the second processing resources retrieve the plurality of decoded data blocks from the data buffer in response to the service processing interrupt and process the plurality of decoded data blocks.

### BACKGROUND

1. Technical Field

The present invention relates generally to wireless communication systems; and more particularly to the servicing of high rate data communications by a wireless device.

2. Related Art

Cellular wireless communication systems support wireless communication services in many populated areas of the world. Cellular wireless communication systems include a “network infrastructure” that wirelessly communicates with wireless terminals within a respective service coverage area. The network infrastructure typically includes a plurality of base stations dispersed throughout the service coverage area, each of which supports wireless communications within a respective cell (or set of sectors). The base stations couple to base station controllers (BSCs) or equivalent devices, with each BSC serving a plurality of base stations. Each BSC couples to a mobile switching center (MSC) or equivalent device and also typically directly or indirectly couples to one or more data networks including the Internet.

In operation, each base station communicates with a plurality of wireless terminals operating in its serviced cell/sectors. A BSC coupled to the base station routes communications between the MSC and the serving base station. The MSC routes the voice communication to another MSC or to the PSTN. BSCs route data communications between a servicing base station and a coupled packet data network, which may be the Internet. Transmissions from base stations to wireless terminals are referred to as “forward link” transmissions while transmissions from wireless terminals to base stations are referred to as “reverse link” transmissions. The volume of data transmitted on the forward link typically exceeds the volume of data transmitted on the reverse link. Such is the case because data users typically issue commands to request data from data sources, e.g., web servers, and the web servers provide the data to the wireless terminals.

Wireless links between base stations and their serviced wireless terminals typically operate according to one (or more) of a plurality of wireless interface operating standards. These operating standards define the manner in which the wireless links are allocated, setup, serviced, and torn down. Cellular standards include the Global System for Mobile telecommunications (GSM) standards, the North American Code Division Multiple Access (CDMA) standards, the North American Time Division Multiple Access (TDMA) standards, the 3^{rd} Generation Partnership Project (3GPP) standards, namely the Universal Mobile Telecommunications Services (UMTS)/Wideband CDMA (WCDMA) standards, the 1xRTT standards, the 1xEV-DO standards, and the 1xEV-DV standards, and among others.

Some of these operating standards, e.g., the High Speed Data Packet Access (HSDPA) standards, the High Speed Uplink Packet Access (HSUPA) standards, the 1xEV-DO standards, and the 1xEV-DV standards, for example, support high rate data communications. Such high rate data communications are of great benefits to both the users of data terminals supported by the systems and the operators that charge relatively large user fees for such data services. However, servicing such high rate data communications is problematic from a processing perspective. The HSDPA standards, for example, support a 7.2 Mbps downlink. Receipt of this downlink requires continuous processing by some components of a receiving wireless device and nearly continuous processing by other components of the receiving wireless device, which may be a wireless terminal or a base station. Thus, during this downlink, processing components of the receiving wireless device may be unable to service other necessary processes, such as user interface processes, data manipulation, and other required processes. These operational concerns are also present in high speed Wireless Local Area Networks (WLANs) that operate according to IEEE 802.11x standards for example, Wireless Wide Area Networks (WWANs) that operate according to the WiMAX standards for example, Wireless Personal Area Networks (WPANs) that operate according to the IEEE 802.15 standards for example, and other types of wireless networks that support high rate data transfers. These problems exist in both wireless client devices, e.g., hand-held wireless terminals, wirelessly enabled computers, etc., and wireless infrastructure devices, e.g., base stations, access points, etc.

Thus, a need exists for improved methodologies for concurrently servicing high data rate transfers while supporting other processing requirements of the wireless device.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a portion of a cellular wireless communication system that supports wireless devices operating according to embodiments of the present invention;

FIG. 2 is a block diagram functionally illustrating a wireless device constructed according to the present invention;

FIGS. 3A and 3B are block diagrams generally illustrating wireless protocol interface stacks as they relate to embodiments of the present invention;

FIG. 4 is a block diagram illustrating the manner in which first processing resources and second processing resources operate to receive and process data signals according to embodiments of the present invention;

FIGS. 5A and 5B are block diagrams generally illustrating structures of wireless devices according to embodiments of the present invention;

FIGS. 6A and 6B are flow charts illustrating operations of a wireless device according to one or more embodiments of the present invention; and

FIG. 7 is a flow chart illustrating operations of first processing circuitry according to one or more embodiments of the present invention.

### DETAILED DESCRIPTION OF THE DRAWINGS

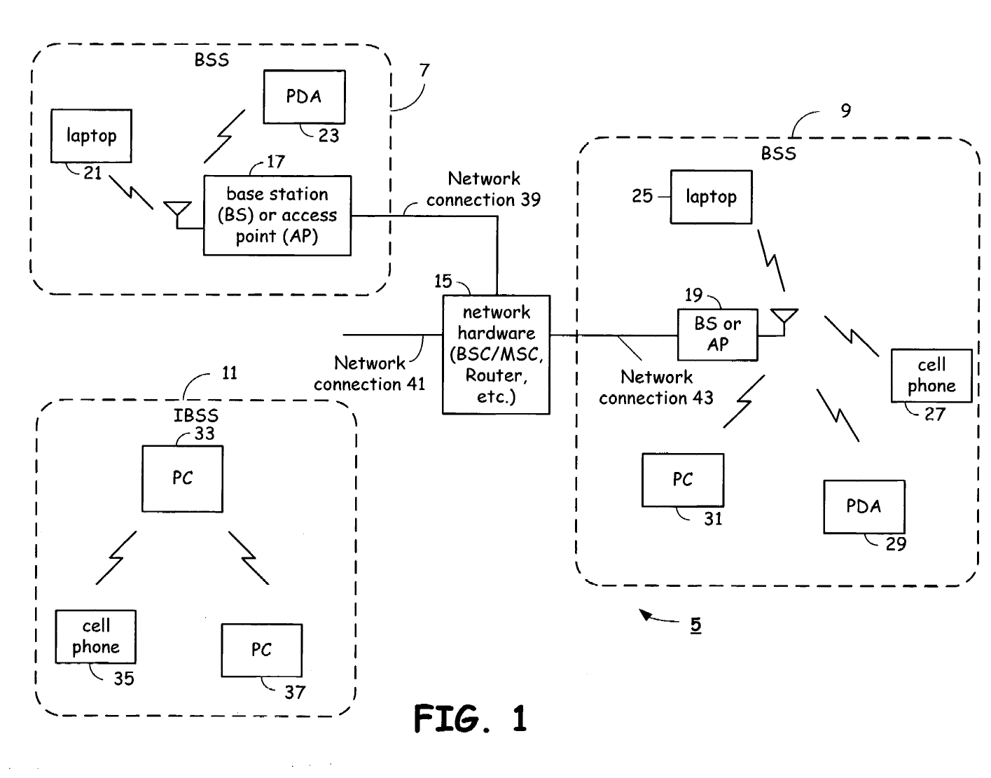

FIG. 1 is a system diagram illustrating a portion of a cellular wireless communication system that supports wireless devices operating according to embodiments of the present invention. The principles of the present invention are applicable to any system that supports data networking. Thus the structure of FIG. 1 will be described herein for cellular communication systems, Wireless Local Area Networks (WLANs), Wireless Wide Area Networks (WWANs), and Wireless Personal Area Networks (WPANs). However, the principles of the present invention apply to other types of wireless systems as well.

Each of a plurality of service areas (cells/sectors/coverage areas) 7 and 9 is serviced by a base station and/or access point 17, 19 that supports wireless communications with a plurality of wireless devices 21-23, 25-31. In supporting cellular communications, each of the base stations 17 and 19 supports one or more cellular standards that may include the Global System for Mobile telecommunications (GSM) standards, the North American Code Division Multiple Access (CDMA) standards, the North American Time Division Multiple Access (TDMA) standards, the 3^{rd} Generation Partnership Project (3GPP) standards, the 1xRTT standards, the 1xEV-DO standards, the 1xEV-DV standards, and the Universal Mobile Telecommunications Services (UMTS)/Wideband CDMA (WCDMA) standards, among others. These supported standards may further include the High Speed Data Packet Access (HSDPA) standards, the High Speed Uplink Packet Access standards, the 1xEV-DO standards, and the 1xEV-DV standards, for example, that specifically support high rate data communications.

In supporting other types of wireless systems, e.g., WLAN systems, WWAN systems, access points 7 and 9 support a WLAN standard such as one or more of the IEEE 802.11x standards, a WWAN standard such as WiMAX standard, or another wireless interface standard that supports high rate data transfers. Typically, base stations are used for cellular telephone systems and like-type systems, while access points are used for in-home or in-building wireless networks. Regardless of the particular type of communication system, each base station/access point 7 and 9 and wireless device 21-23 and 25-31 includes a built-in radio transceiver and/or is coupled to a radio transceiver to facilitate direct and/or in-direct wireless communications within the communication system 5. An IBSS 11 services a plurality of wireless devices 33-37 and operates according to a WLAN standard such as one or more of the IEEE 802.11s standards, a WPAN standard such as the Bluetooth standards or the IEEE 802.15 standards, or other wireless interface standards that support direct communication between wireless devices without an infrastructure base station/access point. Each of the wireless devices 21-37 may be laptop host computers 21 and 25, personal digital assistant hosts 23 and 29, personal computer hosts 31 and 33, and/or cellular telephone hosts 27 and 35.

The base stations/access points 17 and 19 are operably coupled to network hardware 15 via network connections 39 and 43. The network hardware 15, which may be a Base Station Controller (BSC), a Mobile Switching Station (MSC), a Radio Network Controller (RNC), router, switch, bridge, modem, system controller, et cetera, provides a network connection 41 for the communication system 5. Each of the base stations or access points 17, 19 has an associated antenna or antenna array to communicate with the wireless devices in its area. Typically, the wireless devices register with a particular base station or access point 17, 19 to receive services from the communication system 5. For direct connections (i.e., point-to-point communications) within IBSS 11, wireless devices 33-37 communicate directly via an allocated channel.

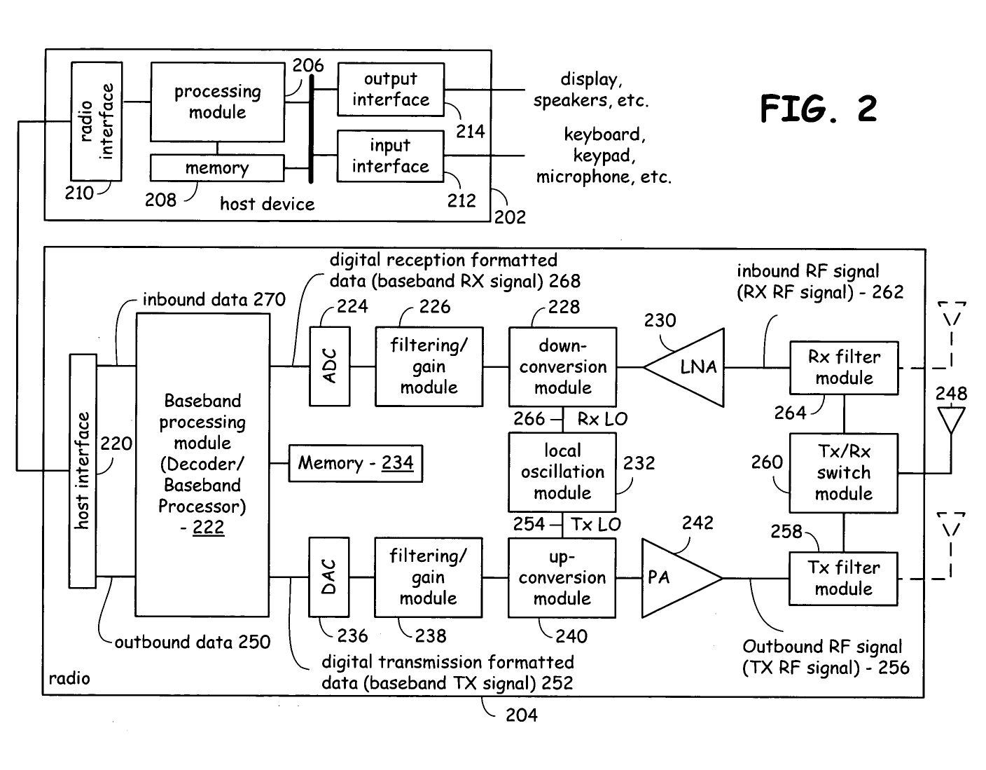

The principles of the present invention apply to each of the wireless devices 21-23, 25-29, and 33-37 as well as to each of the base stations/access points 17 and 19. Generally, the structure and operations of the present invention allow a wireless device to service a high speed data transfer while servicing its other processing requirements. The principles of the present invention will be described further with reference to particular embodiments of FIGS. 2-7.

FIG. 2 is a block diagram functionally illustrating a wireless device constructed according to the present invention. The wireless device may be one of the wireless devices of FIG. 1 or one of the base station/access points of FIG. 1. The wireless device includes host processing components 202 and an associated radio 204. For cellular telephones, for WLAN phones, for WWAN phones, and for other particular devices, the host processing components and the radio 204 are typically contained within a single housing. In some cellular telephones, the host processing components 202 and some or all of the components of the radio 204 are formed on a single Integrated Circuit (IC). For personal digital assistants hosts, laptop hosts, and/or personal computer hosts, the radio 204 may reside within an expansion card or upon a mother board and, therefore, be housed separately from the host processing components 202. The host processing components 202 include at least a processing module 206, memory 208, radio interface 210, an input interface 212, and an output interface 214. The processing module 206 and memory 208 execute instructions to support host terminal functions. For example, for a cellular telephone host device, the processing module 206 performs user interface operations and executes host software programs among other operations.

The radio interface 210 allows data to be received from and sent to the radio 204. For data received from the radio 204 (e.g., inbound data), the radio interface 210 provides the data to the processing module 206 for further processing and/or routing to the output interface 214. The output interface 214 provides connectivity to an output display device such as a display, monitor, speakers, et cetera such that the received data may be displayed. The radio interface 210 also provides data from the processing module 206 to the radio 204. The processing module 206 may receive the outbound data from an input device such as a keyboard, keypad, microphone, et cetera via the input interface 212 or generate the data itself. For data received via the input interface 212, the processing module 206 may perform a corresponding host function on the data and/or route it to the radio 204 via the radio interface 210.

Radio 204 includes a host interface 220, baseband processing module 222 (baseband processor) 222, analog-to-digital converter 224, filtering/gain module 226, down conversion module 228, low noise amplifier 230, local oscillation module 232, memory 234, digital-to-analog converter 236, filtering/gain module 238, up-conversion module 240, power amplifier 242, RX filter module 264, TX filter module 258, TX/RX switch module 260, and antenna 248. Antenna 248 may be a single antenna that is shared by transmit and receive paths (half-duplex) or may include separate antennas for the transmit path and receive path (full-duplex). The antenna implementation will depend on the particular standard to which the wireless communication device is compliant.

The baseband processing module 222 includes one or more processing devices, some of which may be dedicated hardware components and some of which may be digital processors that execute operational instructions such as software instructions or firmware instructions. The baseband processing module 222 in combination with operational instructions stored in memory 234, execute digital receiver functions and digital transmitter functions. The digital receiver functions include, but are not limited to, digital intermediate frequency to baseband conversion, demodulation, constellation demapping, descrambling, and/or decoding. The digital transmitter functions include, but are not limited to, encoding, scrambling, constellation mapping, modulation, and/or digital baseband to IF conversion. Transmit and receive functions provided by the baseband processing module 222 may be implemented using shared processing devices and/or individual processing devices.

Processing devices, such as the baseband processing module 222, may include microprocessors, micro-controllers, digital signal processors, microcomputers, central processing units, field programmable gate arrays, programmable logic devices, state machines, logic circuitry, analog circuitry, digital circuitry, and/or any device that manipulates signals (analog and/or digital) based on operational instructions. The memory 234 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 222 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 204 receives outbound data 250 from the host processing components via the host interface 220. The host interface 220 routes the outbound data 250 to the baseband processing module 222, which processes the outbound data 250 in accordance with a particular wireless communication standard (e.g., UMTS/WCDMA, GSM, GPRS, EDGE, HSDPA, HSUPA, 802.11x, WiMAX, 802.15, Bluetooth, et cetera) to produce digital transmission formatted data 252. The digital transmission formatted data 252 is a digital base-band signal or a digital low IF signal, where the low IF will be in the frequency range of zero to a few kilohertz/megahertz.

The digital-to-analog converter 236 converts the digital transmission formatted data 252 from the digital domain to the analog domain. The filtering/gain module 238 filters and/or adjusts the gain of the analog signal prior to providing it to the up-conversion module 240. The up-conversion module 240 directly or in a multi-step process converts the analog baseband or low IF signal into an RF signal based on a transmitter local oscillation 254 provided by local oscillation module 232. The power amplifier 242 amplifies the RF signal to produce outbound RF signal 256, which is filtered by the TX filter module 258. The TX/RX switch module 260 receives the amplified and filtered RF signal from the TX filter module 258 and provides the output RF signal 256 signal to the antenna 248, which transmits the outbound RF signal 256 to a targeted device such as a base station 103-106.

The radio 204 also receives an inbound RF signal 262, which was transmitted by a base station via the antenna 248, the TX/RX switch module 260, and the RX filter module 264. The low noise amplifier 230 receives inbound RF signal 262 and amplifies the inbound RF signal 262 to produce an amplified inbound RF signal. The low noise amplifier 230 provides the amplified inbound RF signal to the down conversion module 228, which converts the amplified inbound RF signal into an inbound low IF signal or baseband signal based on a receiver local oscillation 266 provided by local oscillation module 232. The down conversion module 228 provides the inbound low IF signal (or baseband signal) to the filtering/gain module 226, which filters and/or adjusts the gain of the signal before providing it to the analog to digital converter 224.

The analog-to-digital converter 224 converts the filtered inbound low IF signal (or baseband signal) from the analog domain to the digital domain to produce digital reception formatted data 268. The baseband processing module 222 demodulates, demaps, descrambles, and/or decodes the digital reception formatted data 268 to recapture inbound data 270 in accordance with the particular wireless communication standard being implemented by radio 204. The host interface 220 provides the recaptured inbound data 270 to the host processing components 202 via the radio interface 210.

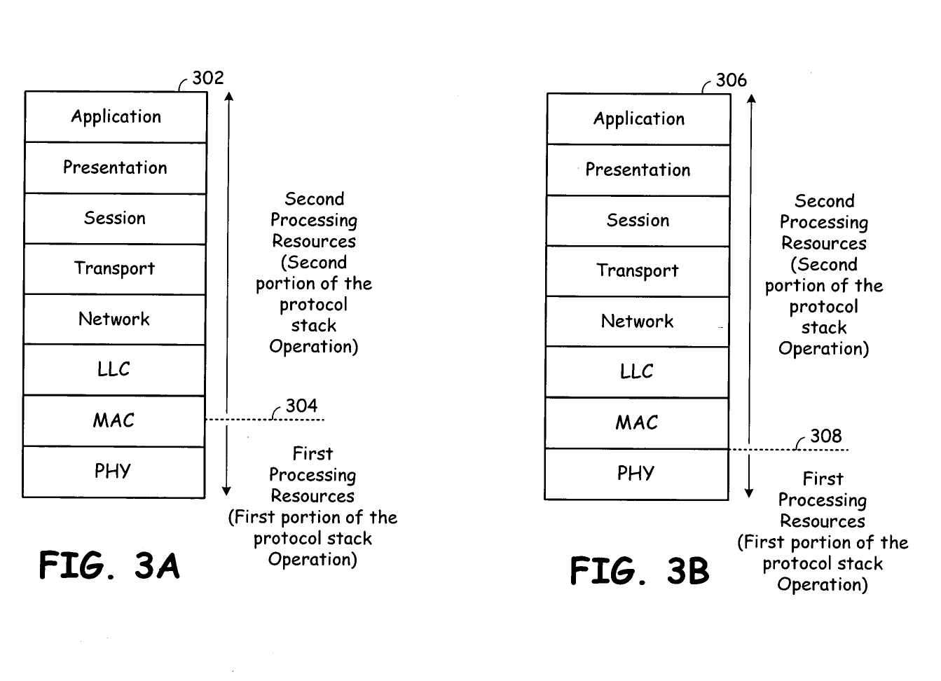

As the reader will appreciate, all components of the radio 204, including the baseband processing module 222 and the RF front end components may be formed on a single integrated circuit. In another construct, the baseband processing module 222 and the RF front end components of the radio 204 may be formed on separate integrated circuits. The radio 204 may be formed on a single integrated circuit along with the host processing components 202. In still other embodiments, the baseband processing module 222 and the host processing components 202 may be formed on separate integrated circuits. Thus, all components of FIG. 2 excluding the antenna, display, speakers, et cetera and keyboard, keypad, microphone, et cetera may be formed on a single integrated circuit. Many differing constructs integrated circuit constructs are possible without departing from the teachings of the present invention. According to the present invention, the baseband processing module 222 includes first and second processing resources interact in such a way to receive incoming data transmissions and still service other of its required functions. Various techniques for performing these operations will be described further herein with reference to FIGS. 3A-7.

FIGS. 3A and 3B are block diagrams generally illustrating wireless protocol interface stacks as they relate to embodiments of the present invention. Referring now to FIG. 3A, a protocol stack 302 for a supported wireless interface protocol is shown. When the wireless device of the present invention supports cellular interface standard(s) such as those previously described, the various layers of the protocol stack correspond to the cellular interface standard(s). The protocol stack 302 includes a PHY layer, a MAC layer, a link layer control layer, a network layer, a transport layer, a session layer, a presentation layer, and an application layer. The components of the protocol stack 302 are generally known and will only be described further herein with reference to FIG. 3A or FIG. 3B as they relate to the operations of embodiments of the present invention.

According to one embodiment of the present invention, the protocol stack operations of protocol stack 302 are supported by multiple processing resources. Generally, first processing resources support a first portion of the protocol stack operations, while second processing resources support a second portion of the protocol stack operations. As is shown in FIG. 3A, the second portion of the protocol stack operations performed by the second processing resources resides functionally above the first portion of the protocol stack operations performed by the first processing resource. According to the embodiment of FIG. 3A, the first processing resources support all of a PHY layer of the protocol stack operations and a portion of the MAC layer of the protocol stack operations. A line of demarcation 304 indicates a separation of the first portion of the protocol stack operations performed by the first processing resources operations and the second portion of the protocol stack operations performed by the second processing resources operations.

According to one particular embodiment of the present invention, the first processing resources support protocol stack operations through channel decoding operations while the second processing resources support protocol stack operations above channel decoding operations. However, in other embodiments, the split between first protocol stack operations second protocol stack operations may differ. Generally, the first processing resources are on-demand to servicing incoming communications while they arrive. Further, generally, the second processing resources support protocol stack operations that may be serviced other than in an always on-demand mode as well as other processing functions as well. Other processing functions supported by the second processing resources may include user interface functions, other data processing functions, video display functions, and audio display functions, among other processing functions that processing resources may support.

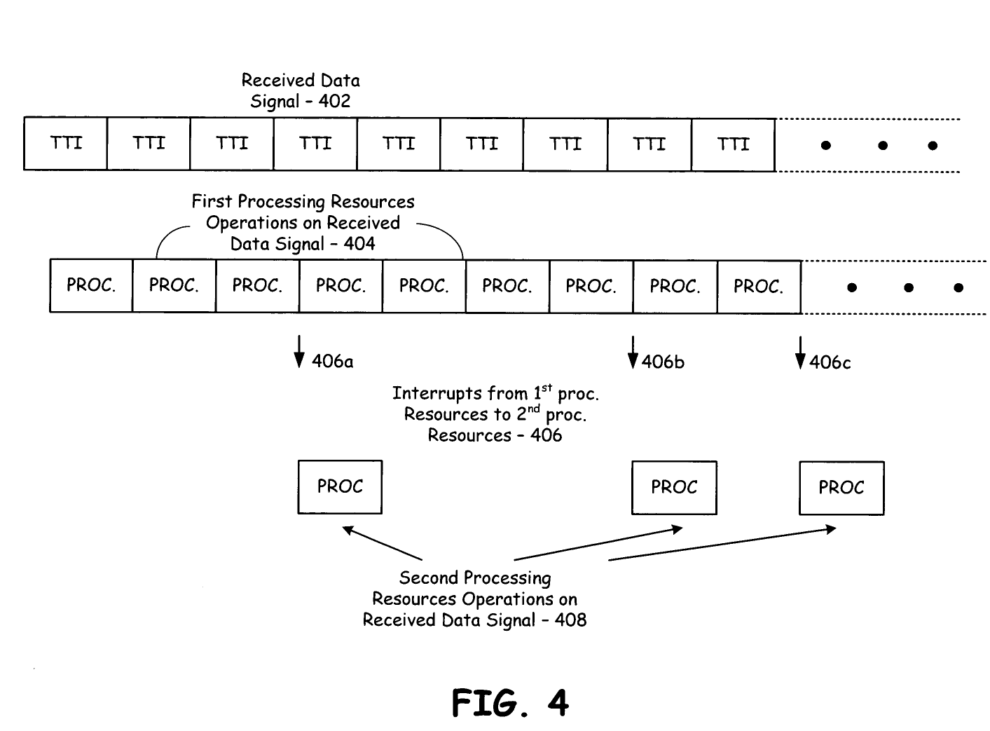

According to one aspect of the embodiment of FIG. 3A, the first processing resources support the first portion of the protocol stack operations during the receipt of a data signal from a transmitting wireless device. The structure of such received data signal and the operations of the first processing resources and the second processing resources will be described further herein with reference to FIG. 4-FIG. 7. Generally, the first processing resources, for each of a plurality of decoded data blocks, receives a data signal from a transmitting wireless device, operates upon the data signal to produce a decoded data block, and writes the decoded data block to a data buffer. Further, the first processing resources determine when a processing resource threshold is met with regard to the plurality of decoded data blocks and, when the processing resource threshold is met, issue a service processing interrupt to the second processing resources. The second processing resources, in response to the service processing interrupt, retrieve the plurality of decoded data blocks from the data buffer and process the plurality of decoded data blocks. In this fashion, the first portion of protocol stack operations supported by the first processing resources may be disassociated from the second portion of protocol stack operations performed by the second processing resources. Such separation of functionality allows the second processing resources to service other processing functions in addition to servicing the second portion of the protocol stack operations.

Referring now to FIG. 3B, a different separation of protocol stack 306 operations is shown. With the example of FIG. 3B, first processing resources service only the physical layer (PHY) of the protocol stack 306, while the second processing resources service all of the MAC layer and the higher protocol layers of the protocol stack operations. The examples of FIG. 3A and FIG. 3B can be extended further such that a line of demarcation 308 as shown to reside between the PHY and MAC layers of protocol stack 306 could reside at any other location without departing from the teachings of the present invention.

FIG. 4 is a block diagram illustrating the manner in which first processing resources and second processing resources operate to receive and process data signals according to embodiments of the present invention. With the example of FIG. 4, a wireless device continually operates upon a received data signal 402. In an HSDPA network, for example, the received data signal 402 is incoming at an effective rate of 7.2 MBPS. Similar rates, higher rates, or lower rates could be supported by different wireless interface standards as serviced by the wireless device. Such other standards could include other cellular standards, other WLAN standards, other WANS standards, and/or WPANS standards. As is shown, received data signal 402 is continually incoming to the wireless device on a slot-by-slot basis. The received data signal 402 would typically be time divided so that it is not continually incoming over all time periods, just during a transmission period from a transmitting wireless device.

Thus, with the example of FIG. 4, the first processing resources perform operations on the received data signal as indicated at 404 continually during the receipt of the data signal 402. The first processing resources perform respective first protocol stack operations on the received data signal 402 to produce decoded data blocks. The first processing resources operate on the received data signal 402 to produce one or more decoded data blocks at the end of each processing interval 404. The first processing resources write the decoded data blocks to a buffer or other storage that is available to the second processing resources. Further, with the example of FIG. 4, the first processing resources determine when a processing resource threshold is met with regard to the plurality of decoded data blocks and, when the processing resource threshold is met, issue a service processing interrupt 406 to the second processing resources. However, the first processing resources do not issue an interrupt 406 to the second processing resources after each processing interval 404. A determination of when to issue a service processing interrupt 406 depends upon the processing resource threshold. In some embodiments, the processing resource threshold is fixed. In other operations, the processing resources threshold varies over time based upon an indication of how busy the second processing resources are in servicing other processes, for example. For example, a first interrupt 406a is produced to the second processes resources at the completion of three processing intervals 404, a second interrupt 406b is produced to the second processing resources at the completion of four processing intervals, and a third interrupt 406c is produced to the second processing.

In response to receipt of the service processing interrupt, the second processing resources retrieve the plurality (in some embodiments) of decoded data blocks from the data buffer and process 408 the plurality of decoded data blocks. The operations performed by the first processing resources include the first protocol stack operations previously described with reference to FIGS. 3A and 3B. The operations performed by the second processing resources 408 include the second protocol stack operations previously described with reference to FIGS. 3A and 3B. In combination, therefore, the first processing resources and the second processing resources service the incoming received data signal 402 to produce data for the wireless device while still servicing the other functions of the wireless device.

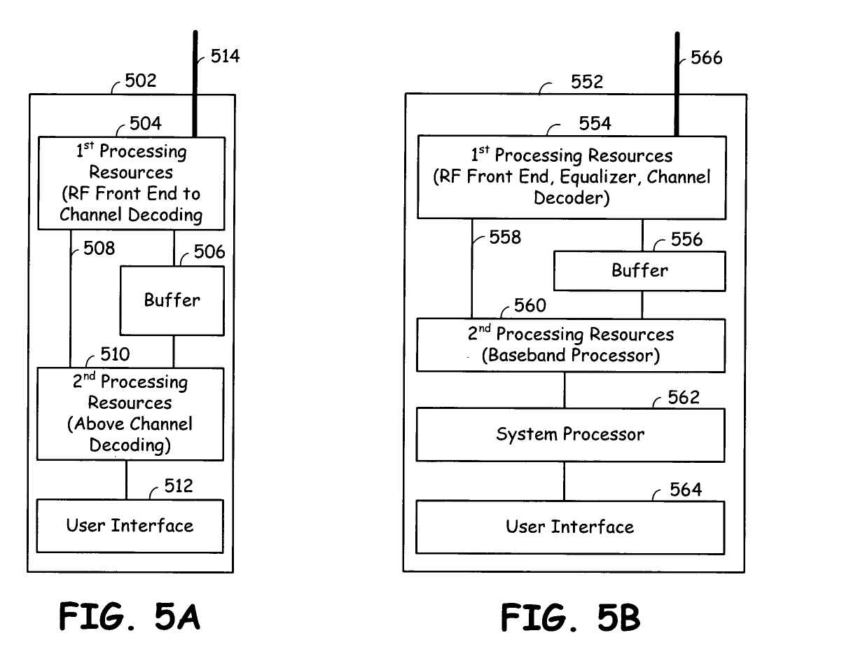

FIGS. 5A and 5B are block diagrams generally illustrating structures of wireless devices according to embodiments of the present invention. Referring now to FIG. 5A, a first embodiment of a wireless device 502 includes first processing resources 504, buffer 506, second processing resources 510, and a user interface 512. The wireless device 502 further includes an antenna 514 and a case. As shown, the first processing resources 504 couples to the antenna. The first processing resources 504 in the embodiment of FIG. 5A include RF front end circuitry and other circuitry necessary to perform first protocol stack operations, such first protocol stack operations to include at least channel decoding operations. With the embodiment of the wireless device 502, the first processing resources 510 may be constructed as dedicated receive path components. Further, the second processing resources 510 may be one or more digital processors that execute software instructions and operate upon received data to produce output. In one particular example, the second processing resources 510 are a baseband processing module.

Thus, with the embodiment of FIG. 5A, the first processing resources 504 are operable to receive a data signal from a transmitting wireless device via the antenna 514. Then, the first processing resources 504 are operable to perform one or more of gain adjusting the data signal, down converting the data signal, sampling the data signal to produce data signal samples, equalizing the data samples, and decoding the equalized data samples to produce decoded data blocks. Particular circuitry that may be employed to perform the described functions was previously illustrated in FIG. 2 and described with reference thereto.

Upon the production of a decoded data block, the first processing resources 504 write the decoded data block to data buffer 506. After one or more cycles of producing a decoded data block, when a processing resource threshold is met, the first processing resources issue a service processing interrupt to the second processing resources. The second processing resources 510 are operable to, in response to the service processing interrupt, retrieve the plurality of decoded data blocks from the data buffer and to process the plurality of decoded data blocks by servicing the second protocol stack operations. The second processing resources 510 are also operable to service the user interface 512. Servicing user interface 512 may include processing of audio data, processing of video data, and interacting with the user to receive information.

The second processing resources 510 are also operable to perform other functions of the wireless device 502, such as running applications programs such as address book applications, data processing programs, video display programs, music management and playing programs, camera programs, games, and other types of programs that wireless device 502 may support. By the first processing resources 504 not issuing a service processing interrupt at the production of each decoded data block, the second processing resources 510 are better able to service their other processing functions. In one particular example of the operation of wireless device 502, the processing resource threshold corresponds to a maximum number of decoded data blocks, e.g. 5 decoded data blocks. Thus, with this particular example, the first processing resources 504 produce five decoded data blocks before issuing an interrupt to the second processing resources 510. However, the particular number of produced decoded data blocks corresponding to the service processing interrupt may differ from 5. Further, the processing resource threshold may vary over time based upon other processing requirements of the second processing resources 510. For example, if the second processing resources 510 are not currently busy servicing other functions of the wireless device 502, the second processing resources 510 may process each decoded data block as it is produced by the first processing resources 504, e.g., processing resource threshold corresponds to one decoded data block. Then, at other times when the second processing resources 510 are busy, the processing resource threshold may be increased to correspond to a number of decoded data blocks greater than one, e.g., 4, and the second processing resources 510 are not interrupt until this differing threshold is met.

Referring now to FIG. 5B, a wireless device 552 includes first processing resources 554, data buffer 556, second processing resources 560, system processor 562, user interface 564, and antenna 566. As contrasted to the structure of the wireless device 502 of FIG. 5A, the wireless device 552 of FIG. 5B includes both second processing resources 560, which is a baseband processing module, and a system processor 562. In such case, the processing of protocol stack operations in servicing communications may be further subdivided between the second processing resources 560 and system processor 562. The reader should appreciate that the operations of the embodiments illustrated in the present application may be further extended to various numbers of particular processors or particular dedicated hardware or software components and yet not depart from the principals of the present invention.

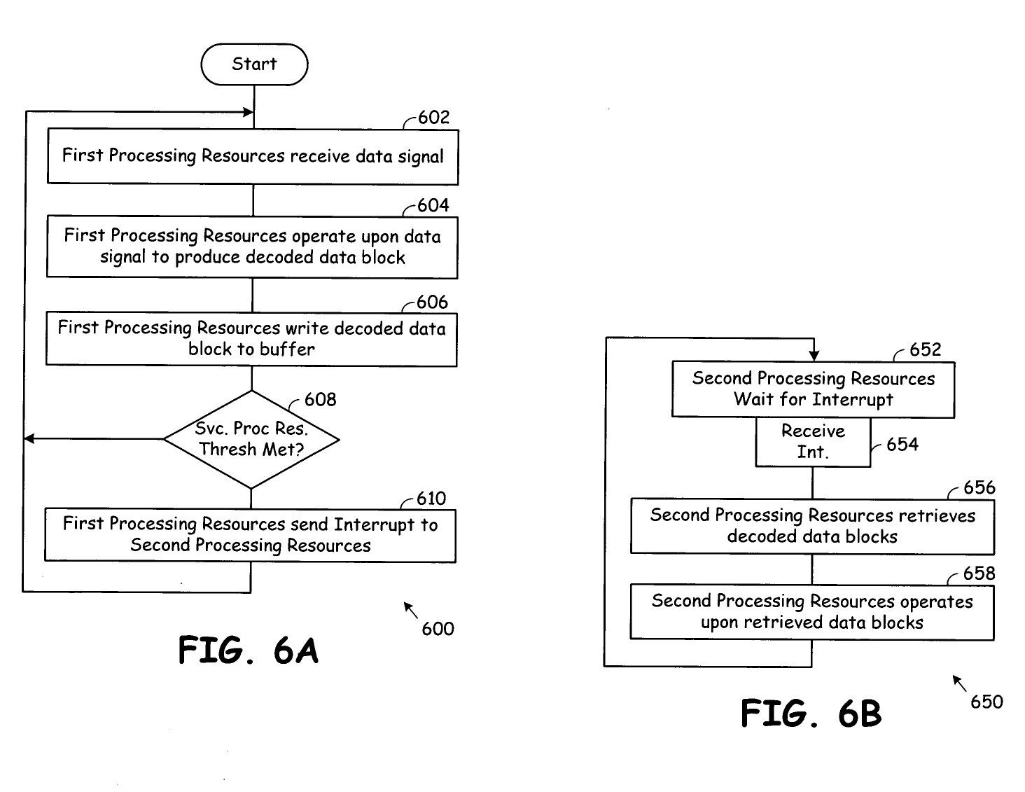

FIGS. 6A and 6B are flow charts illustrating operations of a wireless device according to one or more embodiments of the present invention. Referring now to FIG. 6A, operations 600 of first processing resources commence with the first processing resources receiving a data signal from a transmitting wireless device (step 602). The first processing resources operate upon the data signal to produce a decoded data block (step 604). The first processing resources then write the decoded data block to a data buffer (step 606). The first processing resources then determine whether a service processing resource threshold is met (step 608). If a processing resource threshold is not met, operation returns to step 602. However, if the service processing resource threshold is met, the first processing resources issue an interrupt to the second processing resources (step 610). Thus, as is illustrated in FIG. 6A, the first processing resources are primarily intended to service the incoming data signal as it is transmitted by the transmitting wireless device. That is to say that the first processing resources must be available for the receipt of the data signal from the transmitting wireless device and the processing of such received data signal. Such is the case simply because of the volume of information coming in the received data signal from the transmitting wireless device and because of the instantaneous nature of received analog data signals carrying digital information.

Referring now to FIG. 6B, operations 650 of the second processing resources include first waiting for an interrupt from the first processing resources (step 652). However, in waiting for an interrupt from the first processing resources, the second processing resources are available to perform other required operations of the wireless device, such as were previously described herein. Upon receipt of the interrupt from the first processing resources (step 654), the second processing resources retrieve the decoded data blocks from the data buffer that were stored by the first processing resources (step 656). Then, the second processing resources operate upon the retrieved data blocks (step 658). From step 658, the second processing resources operation returns to step 652. Of course, all the while that the second processing resources performing the operation 650 elsewhere in FIG. 6B, it could also be servicing other processing functions of the wireless device.

According to alternate construct/operation of embodiments of the present invention, the first processing resources could produce a service processing interrupt to the second processing resources upon the production of each decoded data block and circuitry could be employed to reside between the first processing resources and the second processing resources to buffer the interrupts and to decide whether the second processing resources should service such interrupts. In such case, the second processing resources would include the additional structure to buffer interrupts and to decide when to pass the buffered/accumulated interrupts to the second processing resources for servicing.

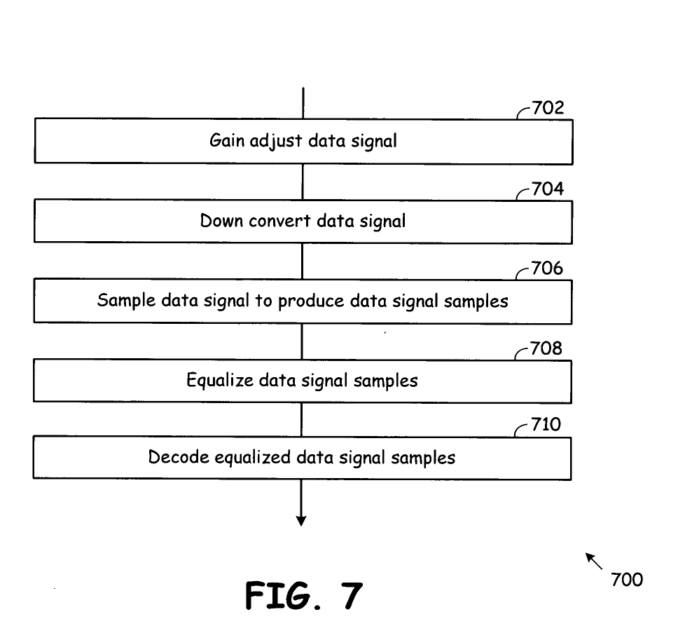

FIG. 7 is a flow chart illustrating operations of first processing circuitry according to one or more embodiments of the present invention. The operations 700 described in FIG. 7 are those performed by the first processing resources in the receipt of the data signal and the operation thereupon. The structure previously illustrated in FIG. 2 may be employed to perform the operations 700 of FIG. 7. Generally, the first processing resources receive the data signal from a transmitting wireless device via an antenna. The first processing resources then gain adjust the data signal (step 702) and then down converts the data signal (step 704). Then, the first processing resources sample the data signal in its down converted state to produce data signal samples (step 706). In the down conversion of step 704 and the sampling of step 706, the sampled signal may be a baseband or a low intermediate frequency. Then, the first processing resources equalize the data signal samples (step 708) and then decode the equalized data signal samples to produce decoded data blocks (step 710). The operations of FIG. 7 correspond to step 604 of FIG. 6.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A method for operating a wireless device that includes first processing resources and second processing resource, the method comprising:
the first processing resources supporting a first portion of protocol stack operations for at least one supported wireless interface protocol;
the second processing resources supporting a second portion of the protocol stack operations for the at least one supported wireless interface protocol, the second portion of the protocol stack operations residing functionally above the first portion of the protocol stack operations;
the first processing resources, for each of a plurality of decoded data blocks:
receiving a data signal from a transmitting wireless device;
operating upon the data signal to produce a decoded data block; and
writing the decoded data block to a data buffer;
the first processing resources:
determining when a processing resource threshold is met with regard to the plurality of decoded data blocks; and
when the processing resource threshold is met, issuing a service processing interrupt to the second processing resources; and
the second processing resources:
retrieving the plurality of decoded data blocks from the data buffer in response to the service processing interrupt; and
processing the plurality of decoded data blocks.

2. The method of claim 1, wherein the processing resource threshold corresponds to a maximum number of decoded data blocks.

3. The method of claim 2, wherein the processing resource threshold corresponds to a pre-selected number of decoded data blocks greater than one.

4. The method of claim 1, wherein the processing resource threshold varies over time based upon other processing requirements of the second processing resources.

5. The method of claim 1, wherein:
the first processing resources comprise dedicated receive path components performing at least amplification, down conversion, sampling, channel equalization, and channel decoding operations; and
the second processing resources comprise at least one processor.

6. The method of claim 5, wherein the channel decoding operations of the first processing resources issue an interrupt to the second processing resources when the processing resource threshold is met.

7. The method of claim 5, wherein the at least one processor comprises a baseband processing module.

8. A method for operating a wireless device that includes first processing resources and second processing resource, the method comprising:
the first processing resources, for each of a plurality of decoded data blocks:
receiving a data signal from a transmitting wireless device;
gain adjusting the data signal;
down converting the data signal;
sampling the data signal to produce data signal samples;
equalizing the data signal samples;
decoding the equalized data samples to produce the decoded data block;
writing the decoded data block to a data buffer; and
the first processing resources:
determining when a processing resource threshold is met with regard to the plurality of decoded data blocks; and
when the processing resource threshold is met, issuing a service processing interrupt to the second processing resources; and
the second processing resources:
retrieving the plurality of decoded data blocks from the data buffer in response to the service processing interrupt; and
processing the plurality of decoded data blocks.

9. The method of claim 8, wherein the processing resource threshold corresponds to a maximum number of decoded data blocks.

10. The method of claim 9, wherein the processing resource threshold corresponds to a pre-selected number of decoded data blocks greater than one.

11. The method of claim 8, wherein the processing resource threshold varies over time based upon other processing requirements of the second processing resources.

12. The method of claim 8, wherein:
the first processing resources comprise dedicated receive path components; and
the second processing resources comprise at least one processor.

13. The method of claim 12, wherein the at least one processor comprises a baseband processing module.

14. A wireless device comprising:
a case;
a user interface;
an antenna;
first processing resources coupled to the antenna;
second processing resources coupled to the first processing resources and to the user interface;
the first processing resources, for each of a plurality of decoded data blocks operable to:
receive a data signal from a transmitting wireless device via the antenna;
gain adjust the data signal;
down convert the data signal;
sample the data signal to produce data signal samples;
equalize the data samples;
decode the equalized data samples to produce the decoded data block; and
issue an interrupt to the second processing resources and write the decoded data block to a data buffer; and
the first processing resources operable to:
determine when a processing resource threshold is met with regard to the plurality of decoded data blocks; and
when the processing resource threshold is met, issue a service processing interrupt to the second processing resources; and the second processing resources operable to:
retrieve the plurality of decoded data blocks from the data buffer in response to the service processing interrupt; and
process the plurality of decoded data blocks.

15. The wireless device of claim 14, wherein:
the first processing resources support a first portion of protocol stack operations for at least one supported wireless interface protocol; and
the second processing resources support a second portion of protocol stack operations for the at least one supported wireless interface protocol, the second portion of the protocol stack operations residing functionally above the first portion of the protocol stack operations.

16. The wireless device of claim 14, wherein the processing resource threshold corresponds to a maximum number of decoded data blocks.

17. The wireless device of claim 16, wherein the processing resource threshold corresponds to a pre-selected number of decoded data blocks greater than one.

18. The wireless device of claim 14, wherein the processing resource threshold varies over time based upon other processing requirements of the second processing resources.

19. The wireless device of claim 14, wherein:
the first processing resources comprise dedicated receive path components; and
the second processing resources comprise at least one processor.

20. The wireless device of claim 19, wherein the at least one processor comprises a baseband processing module.
